(19) United States
(12) Patent Application Publication
(10) Pub. No.: US 2025/0146543 A1
(43) Pub. Date: May 8, 2025

(54) CHANDLER 5 IN 1 LOCOMOTIVE BRAKE SERVICE TOOL

(71) Applicant: Ronny L. Chandler, SR., Memphis, TN (US)

(72) Inventor: Ronny L. Chandler, SR., Memphis, TN (US)

(21) Appl. No.: 18/445,595

(22) Filed: Nov. 8, 2023

(51) Int. Cl. F16D 65/00; B25F 1/00

(52) U.S. Cl. CPC F16D 65/0043; B25F 1/006

(57) ABSTRACT

The Chandler 5 IN 1 Locomotive Brake Service Tool has 5 individual tools all in 1 single component can more efficiently and effectively service the brake system with less time consumption. This tool has a right-side fork to remove the pin from the right-side brake shoe and it has a left-side fork to remove the pin from the left-side brake shoe, hammerhead slack adjuster pin removal, punch tip for adjusting slack and prybar for slack pin tab retainer.

### FIELD

The present application relates to the Chandler 5 IN 1 Locomotive Brake Service Tool, to reflect how it is a more useful and improved locomotive brake service tool through its operational elements in providing efficiency in safely changing brakes more effectively and with less time consumption.

### BACKGROUND

In earlier years the locomotive brake services effort was extremely limited and not very reliable, relying on limited resources such as a screw and linkage system to apply brake blocks.

As the locomotive industry has continued to evolve over the years as train speeds increased, it became essential to provide a more powerful braking system capable of instant application.

Today, locomotive brake service systems are equipped with sophisticated brake systems that allows more control over the acceleration system and parking, but there is still a need for brake shoe replacements with expedience and accuracy while still meeting the safety requirements needed to stay within regulations.

### SUMMARY

By providing the locomotive industry with the Chandler 5 IN 1 Locomotive Brake Service Tool, the elements of this tool are so versatile, that there is no other tool designed with the functionality like this tool on the world market. This tool will safely and efficiently with less time consumption can be used at railroad service yards all over the world. This tool can effectively remove and install all new brake shoes on cover hopper railcars, railroad box cars, open gondola rail cars, hauler cars, tanker cars, flat bed railroad cars and so many more. This tool can set the slack adjuster on any locomotive or on any type of railroad car completely and safely within a short time frame.

This tool will allow any engineer conductor and service track engineer will be able to set the brakes inside the cab of the locomotive, then climb out onto the ground and go to the wheels on the locomotive. Use the air release handle to remove the air pressure from that set of locomotive wheels, then take the tool and with the prybar of the tool, push the brake shoe away from the wheel of the locomotive, then take the prybar and lift the slack adjuster retainer clip so the slack adjuster pin can be pushed out of the slack adjuster rod using the hammer head on the tool.

After the pin is removed there's no pressure on the brake shoe assembly, that's when the claw feet of the tool can grab the metal head of the brake shoe radius retainer pin and pull it out of the brake shoe retainer slot, releasing the brake shoe so it can be removed and a new brake shoe put in its place and the radius brake shoe retainer pin can be pushed back down through the brake shoe retainer holes. The new shoe is now in place to engage the locomotive wheel when air pressure is applied to the air piston. Now the slack adjuster's slack must be taken up, that's where the adjustment pin and the tool take up the slack and aligns the hole in the slack adjuster.

The slack adjuster pin can now be reinstalled and its retainer clip pushed back in place with the prybar part of the tool, the brake pads have now been installed and the air brake valve handle can reapply air pressure to the cylinder. That set of brakes is now installed safely and you can now move on to the next set of brake shoes until all the necessary brake shoes needed are installed on the locomotive.

The chocks can be removed from the wheels and the engineer conductor or service track engineer can climb back up in the locomotive cab and start up the locomotive and release the air brakes and move the engine at will. The brake replacement job is completed using the Chandler 5 IN 1 Locomotive Brake Service Tool.

### BRIEF DESCRIPTION OF THE DRAWINGS

In the following present application, you will see a detailed description the drawing embodiments shown.

FIG. 1 is a top front perspective view of a locomotive brake service tool, showing my new more useful and improved original creation.

FIG. 2 is a right-side elevation view thereof;

FIG. 3 is a top plan view thereof;

FIG. 4 is a front elevation view thereof, with the rear elevation view being a mirror image thereof;

FIG. 5 is a bottom plan view thereof;

FIG. 6 is a left elevation view thereof; and

FIG. 7 is a bottom rear perspective view thereof.

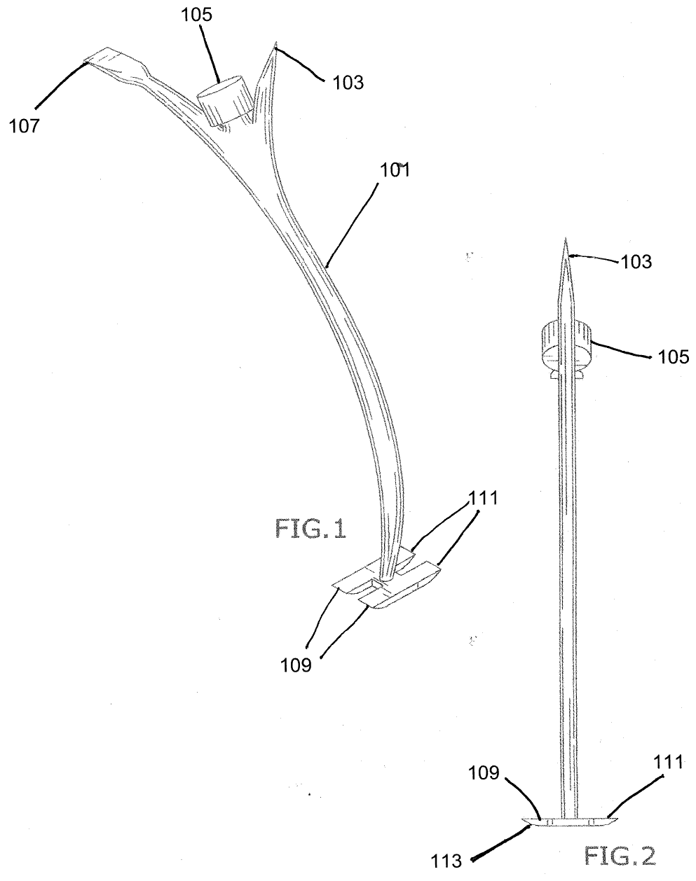

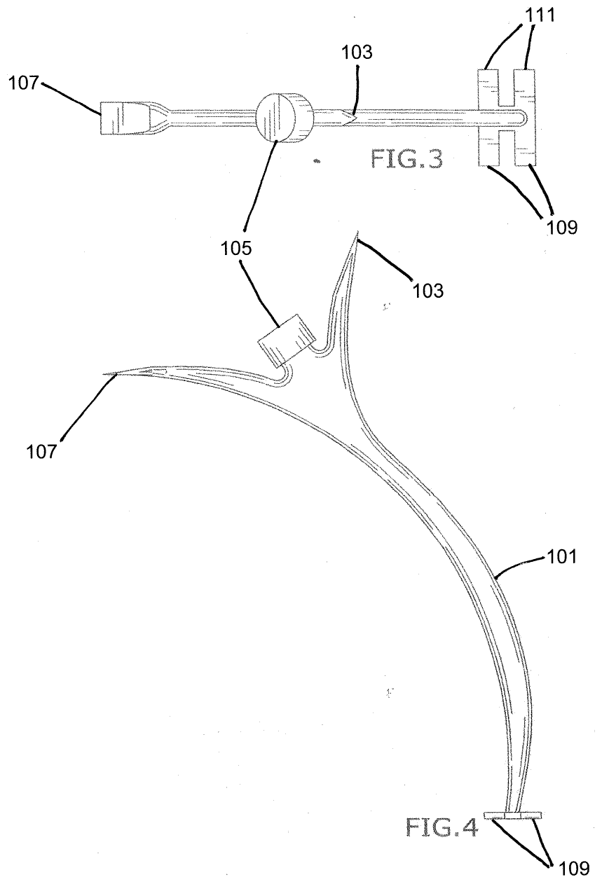

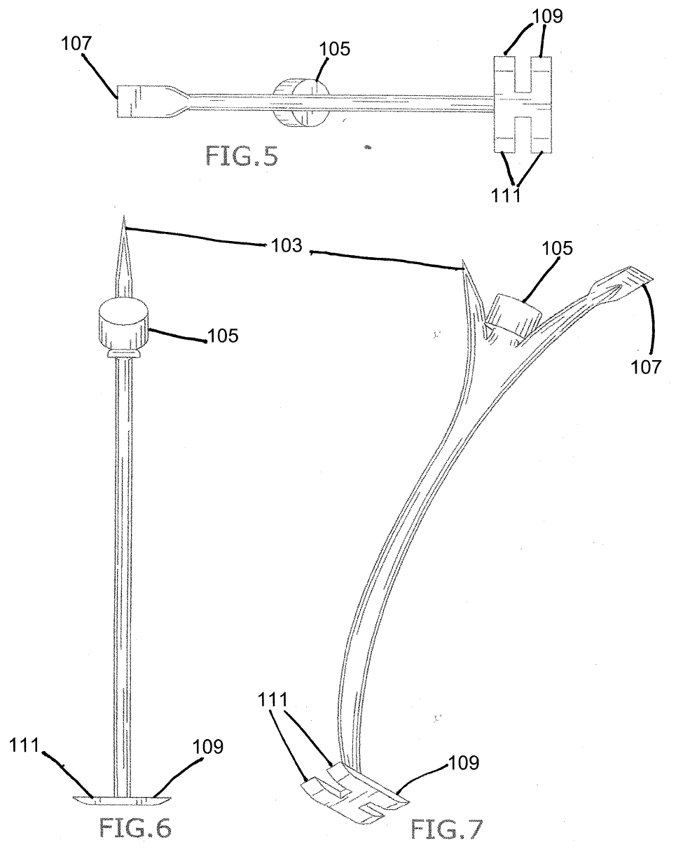

### DETAILED DESCRIPTION

In the following detailed description, it will reflect the elements of the CHANDLER 5 N 1 LOCOMOTIVE BRAKE SERVICE TOOL present application. This tool was created to specifically service and install brake shoes on locomotives by removing the brake pin retainer tab that secures a pin that maintains slack pressure on the brake pads from the slack adjuster. The tool has a double head brake pin removal foot that grabs the brake shoe retainer pin and allows the tool to pull the pin out of the brake shoe holder assembly, which allows the user to remove the worn-out brake shoe and install a new brake shoe in that precise brake shoe assembly.

There are eight- and twelve-wheel locomotives worldwide this tool will enable the new brake shoe retainer pin to be reinstalled to hold the brake shoe securely in the brake shoe holder assembly. Then the tool allows the user to tighten up the slack adjuster to put pressure on the shoes. Then the tool allows the pin retainer tab to be put back into position holding the pin in the slack adjuster rod assembly. The brake shoe replacement job is now finished, now the air valve can be turned back on at the brake assembly, so the engineer can now apply the brakes to the wheels from up in the cab. This is a new original creation utility, a locomotive brake service tool that is more useful and improved in changing brakes more effectively and less time consuming.

Railway systems are built in a variety gauges or track widths around the world with the standard gauge of 4 foot 8.5 inches being the predominant system. Rolling stock, such as locomotives and railcars, typically has a standard wheel diameter of 36 inches (920 mm). This standard wheel diameter has been defined by The International Union of Railways, with some rapid transit railway systems using smaller diameter wheels.

According to various teachings of the present disclosure, disclosed is a multi-purpose tool for replacing brake shoes having a handle member having left and right sides, and proximate and distal ends, an H-shaped member having a centroid, located at the distal end of the handle member, featuring two spaced apart tines forming a left fork and right fork, and a tri-tool assembly, located at the proximate end of the handle member, containing a prybar end, a centrally-located hammer head, and a punch, with the distal end of the handle member attached at the centroid of the H-shaped member.

In some embodiments, the handle member is curved, and in further instances, the handle member is curved to conform to the curvature of the radius of an installed brake shoe on a wheel of a standard gauge railcar. As set forth above, the diameter of a standard gauge railcar is 36 inches (920 mm).

The curved handle member which is connected to the centroid of H-shaped member at its distal end curves above a horizontal line bisecting the crossbar of the H-shaped member. This arrangement allows for unobstructed access to the opening of both of the left and right forks of the H-shaped member, and permits the disclosed device to used to remove brake shoe retainer pins.

The H-shaped member of the presently disclosed tool has a flat bottom portion with an angled portion connecting up to the top portion of the H-shaped assembly, and in preferred embodiments the angled portion comprises a 30 degree angle. This specific configuration facilitates removal of brake shoe retainer pins on both left and right wheels of a railcar truck. A pair of wheelsets are mounted in railcar truck.

As illustrated in the Figures, the H-shaped assembly has four tines, in two pairs, that are spaced apart by the diameter of a brake shoe retainer pin.

Also taught by the present disclosure is a method of removing and replacing a brake shoe of a railcar, the method requires an installation tool for removing and replacing railcar brake shoes. The installation tool includes a handle member having left and right sides, and proximate and distal ends, an H-shaped member having a centroid, located at the distal end of the handle member, comprising two spaced apart tines forming a left fork and right fork, and a tri-tool assembly, located at the proximate end of the handle member, comprising a prybar end, a centrally-located hammer head, and a punch, with the distal end of the handle member attached at the centroid of the H-shaped member. The method includes the steps of activating an air release handle to remove the air pressure from a set of locomotive wheels, obtaining the above-described installation tool, and then pushing the brake shoe away from the locomotive wheel with the prybar end, lifting a slack adjuster retainer clip with the prybar end, and knocking a slack adjuster pin out of a slack adjuster rod with the hammer head. Next step is grabbing a metal head of a brake shoe retainer pin with the one fork of the tool, pulling brake shoe retainer pin out of the brake shoe retainer slot, and releasing and removing an old brake shoe. Then the replacing portion of the method starts with installing a new brake shoe in the brake shoe retainer slot, pushing the brake shoe retainer pin back through the brake shoe retainer holes, taking up the slack in a slack adjuster by inserting the punch in an outer slack adjuster hole, applying pressure, and aligning the hole in the slack adjuster, knocking a slack adjuster hole pin back in with the hammer head, and pushing the retainer clip back in place with the prybar end. Thus, a first worn brake shoe is replaced with the method and tool disclosed in the present application.

The work continues with the step of proceeding to a next set of brake shoes, removing and replacing the brake shoes as needed, and continuing on until all the necessary brake shoes are removed and replaced.

As presented in the attached Figures, one possible embodiment of the presently disclosed device is the multi-purpose tool of FIG. 1 featuring a handle member 101 having left and right sides, and proximate and distal ends, with an H-shaped member having a centroid, located at the distal end of the handle member, comprising two spaced apart tines forming a left fork 109 and right fork 111, and located at the proximate end of the handle member, a tri-tool assembly, which includes a prybar end 107, a centrally-located hammer head 105, and a punch 103.

In some embodiments of the present teachings, the H-shaped member has a flat bottom surface that connects to the top surface with angled sides 113 with angles of about 30 degrees.

According to several embodiments of the disclosed device, the overall length of the device as measured from the end of the tines on the left fork 109 to the tip of the punch 103 is about 19 inches (482 mm), and the distance between the right fork 111 to the tip of the prybar end 107 is about 18 inches (457 mm). The width at the proximate end as measured between the tip of the punch to the tip of the prybar end is about 9 inches (229 mm).

The H-shaped assembly at the distal end of the handle according to various embodiments of the present teachings measures 3 inches (76.2 mm) by 1.75 inches (44.4 mm) with an opening of 0.625 inches (16 mm) between the tines on the short side of the H-shaped assembly. On the proximate end, the prybar end measures 4.75 inches (120 mm) from the center of the hammer head which measures 1.5 inches (38 mm) in diameter while the punch is 4.25 inches (229 mm) in length.

Although the foregoing description is directed to the preferred embodiments of the present teachings, it is noted that other variations and modifications will be apparent to those skilled in the art, and which may be made without departing from the spirit or scope of the present teachings. The provided figures are not to scale, and the angles between various members of the apparatus are merely illustrative.

The foregoing detailed description of the various embodiments of the present teachings has been provided for the purposes of illustration and description. It is not intended to be exhaustive or to limit the present teachings to the precise embodiments disclosed. Many modifications and variations will be apparent to practitioners skilled in this art. The embodiments were chosen and described in order to best explain the principles of the present teachings and their practical application, thereby enabling others skilled in the art to understand the present teachings for various embodiments and with various modifications as are suited to the particular use contemplated. It is intended that the scope of the present teachings be defined by the following claims and their equivalents.

1-5. (canceled)

6. A multi-purpose tool for replacing brake shoes, comprising
a handle member having left and right sides, and proximate and distal ends;
an H-shaped member having a centroid, located at the distal end of the handle member, comprising two spaced apart tines forming a left fork and right fork, and
a tri-tool assembly, located at the proximate end of the handle member, comprising a prybar end, a centrally-located hammer head, and a punch,
wherein the distal end of the handle member is attached at the centroid of the H-shaped member.

7. The multi-purpose tool according to claim 6, wherein the handle member is curved.

8. The multi-purpose tool according to claim 7, wherein the handle member is curved to conform to the curvature of the radius of an installed brake shoe on a wheel of a standard gauge railcar.

9. The multi-purpose tool according to claim 6, wherein the handle member curves above a horizontal line bisecting the crossbar of the H-shaped member.

10. The multi-purpose tool according to claim 6, wherein the H-shaped member comprises a flat bottom portion with an angled portion connecting up to the top portion of the H-shaped assembly.

11. The multi-purpose tool according to claim 10, wherein the angled portion comprises a 30 degree angle.

12. The multi-purpose tool according to claim 6, wherein the tines are spaced apart by the diameter of a brake shoe retainer pin.

13. A method of removing and replacing a brake shoe of a railcar, comprising
activating an air release handle to remove the air pressure from a set of locomotive wheels;
obtaining an installation tool for removing and replacing railcar brake shoes, the installation tool comprising:
a handle member having left and right sides, and proximate and distal ends;
an H-shaped member having a centroid, located at the distal end of the handle member, comprising two spaced apart tines forming a left fork and right fork, and
a tri-tool assembly, located at the proximate end of the handle member, comprising a prybar end, a centrally-located hammer head, and a punch,
wherein the distal end of the handle member is attached at the centroid of the H-shaped member;
pushing the brake shoe away from the locomotive wheel with the prybar end;
lifting a slack adjuster retainer clip with the prybar end;
knocking a slack adjuster pin out of a slack adjuster rod with the hammer head;
grabbing a metal head of a brake shoe retainer pin with the one fork of the tool;
pulling brake shoe retainer pin out of the brake shoe retainer slot;
releasing and removing an old brake shoe;
installing a new brake shoe in the brake shoe retainer slot;
pushing the brake shoe retainer pin back through the brake shoe retainer holes;
taking up the slack in a slack adjuster by inserting the punch in an outer slack adjuster hole, applying pressure, and aligning the hole in the slack adjuster;
knocking a slack adjuster hole pin back in with the hammer head, and
pushing the retainer clip back in place with the prybar end.

14. The method according to claim 13, further comprising
proceeding to a next set of brake shoes;
removing and replacing the brake shoes as needed, and
continuing on until all the necessary brake shoes are removed and replaced.

15. A multi-purpose tool for replacing brake shoes on a railroad car, comprising
an H-shaped member;
a handle member, and
a tri-tool assembly,
wherein the H-shaped member connected at its centroid to a first end of the handle member comprises two spaced apart tines forming a left fork and right fork, and a tri-tool assembly connected at a second end of the handle member comprises a prybar end, a centrally-located hammer head, and a punch.
